(19) United States
(12) Patent Application Publication
(10) Pub. No.: US 2010/0109522 A1
(43) Pub. Date: May 6, 2010

(54) MERCURY-FREE HIGH INTENSITY GAS-DISCHARGE LAMP

(75) Inventors: Michael Haacke, Aachen (DE); Kirsten Gerta Baumges, Viersen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/593,380

(22) PCT Filed: Mar. 31, 2008
(86) PCT No.: PCT/IB08/51194

§ 371 Date: Sep. 28, 2009

(30) Foreign Application Priority Data
Apr. 5, 2007 (EP) 07105746.7

(51) Int. Cl. H01J 61/12

(52) U.S. Cl. 313/570

(57) ABSTRACT

The invention describes a mercury-free high intensity gas-discharge lamp (1) with nominal power in the range of 25 W to 40 W, and in particular with nominal power of 35 W, comprising a quartz glass discharge chamber (2) enclosing a fill gas and comprising a pair of electrodes (3, 4) arranged at opposing ends of the discharge chamber (2) and extending into the discharge chamber (2), for which lamp (1) the capacity of the discharge chamber (2) is greater than or equal to 17 μl and less than or equal to 25 μl; the inner diameter of the discharge chamber (2) is at least 2.3 mm and at most 2.5 mm; the outer diameter of the discharge chamber (2) is at least 5.95 mm and at most 6.15 mm; the thickness of the discharge chamber (2) is at least 3.45 mm and at most 3.85 mm. The fill gas in the discharge chamber (2) of the lamp (1) includes a halide composition comprising sodium iodide NaI and scandium iodide ScI₃, whereby the proportion of sodium iodide in the halide composition is at least 62 wt % and at most 76 wt %, and the proportion of scandium iodide in the halide composition is at least 22 wt % and at most 32 wt %. Furthermore, the fill gas comprises xenon gas under a pressure of at least 13 bar in a non-operational state, such that a colour temperature in the range of 3550K to 3850K is attained by the lamp (1) when operated with an initial operating voltage of at least 39V and at most 51V.

The invention describes a mercury-free high intensity discharge lamp.

In a high-intensity discharge lamp, an electric arc established between two electrodes produces an intensely bright light. Such a lamp is often simply referred to as an ‘HID’ lamp. In prior art HID lamps, a discharge chamber contains a fill gas comprising largely xenon and a combination of halides—usually sodium iodide and scandium iodide—and one or more other metal salts that vaporise during operation of the lamp. Because the fill gas largely comprises xenon, these lamps can also be referred to as xenon lamps. When used in automotive headlamp applications, HID lamps have a number of advantages over other types of lamp. For instance, the light output of a metal halide xenon lamp is greater than that of a comparable tungsten-halogen lamp. Also, HID lamps have a significantly longer lifetime than filament lamps, and are not subject to blackening. These and other advantages make HID lamps particularly suited for automotive headlamp applications.

The light output of a xenon lamp is characterised by a distinct whiteness or even a bluish tint. Also, unlike the light output of a filament lamp, a xenon lamp provides a light output whose spectral power distribution is not continuous. Prior art automotive headlamps using D2 or D4 (mercury-free) HID lamps provide a light output with a colour temperature of more than 4000K, tending towards whiteness. The colour point, or colour temperature, of an automotive HID lamp is crucial for safety. Firstly, the HID headlamps of a vehicle must sufficiently illuminate the road for the driver of that vehicle, and secondly, other drivers should not be subject to potentially dangerous glare from the headlamps of that vehicle. The intense white light of prior art HID lamps can be a problem. For this reason, some countries such as Japan regulate the permissible colour temperatures of automotive HID lamps to a level lower, i.e. less white, than that provided by the prior art D2 and D4 type lamps, so that the market for these lamps is effectively restricted.

Along with the colour temperature, other characteristics of such lamps, for example operational voltage, lamp driver characteristics, dimensions, etc., are specified in different countries by the appropriate regulations, for example by ECE-R99 in Europe, where ‘ECE’ stands for ‘Economic Commission for Europe’.

Also, for the safety of motorcyclists, it is desirable to have a motorcycle headlamp with a colour temperature distinct from that of an automobile headlamp. A HID lamp with a colour temperature lower than that of an automotive headlamp could increase the safety of motorcyclists in traffic, since a more yellowish light (motorcycle headlamp) can easily be distinguished from among white lights (automobile headlamps). Furthermore, the colour temperature related to this invention (around 3700K) differs significantly from standard non-coated halogen lamps, which deliver a colour temperature between 3000K and 3200K. The human eye can distinguish a colour temperature difference of 100K. Also, compared to standard coated and non-coated halogen lamps, safety aspects for motorcycles can be increased by using a HID lamp owing to their significantly higher lumen output (two to three times higher), their beam scope and their long lifetime. These arguments become even more significant since the introduction of automotive DRL (daytime running lights) in many countries.

The colour point of an HID lamp is governed by many factors. Not only the composition of the fill gas plays an important role. The dimensions of the discharge chamber, and the size and position of the electrodes also have an effect on the colour temperature since they influence the coldest spot temperature, and as a result the partial pressure of salt species.

Some state of the art HID lamps contain a small proportion of the toxic heavy metal mercury. Apart from the obvious environmental considerations, the use of mercury in such lamps is becoming a significant problem for both manufacturers and customers, since the disposal of mercury-containing components is becoming more and more regulated world-wide, leading to additional costs.

DE 101 14 680 A1 describes a mercury-free HID lamp for an operational voltage of 42V, having a fill gas comprising sodium iodide and scandium iodide, but having a colour temperature of 4300K. EP 0 883 160 B1 describes a mercury-free HID lamp with a colour temperature around 3700K, but having an operational voltage above 70V, therefore making it unsuitable for use as a D4 lamp, since the operating voltage of a D4 lamp must lie within range 42V+/−9V after 15 hours of operation, according to the ECE-R99 regulation. Use of the lamp described by EP 0 883 160 B1 would necessitate replacement of the entire lamp driver electronics.

Therefore, it is an object of the invention to provide a mercury-free high-intensity xenon discharge lamp, satisfying the criteria for a D4 automotive headlamp, and having a lower colour temperature while maintaining the efficacy of the lamp.

To this end, the present invention describes a mercury-free gas-discharge lamp with nominal power in the range of 25 W to 40 W, and in particular with nominal power of 35W, comprising a quartz glass discharge chamber enclosing a fill gas and comprising a pair of electrodes arranged at opposing ends of the discharge chamber and extending into the discharge chamber, for which lamp the capacity of the discharge chamber is greater than or equal to 17 μl (microlitres) and less than or equal to 25 μl; the inner diameter of the discharge chamber is at least 2.3 mm and at most 2.5 mm; the outer diameter of the discharge chamber is at least 5.95 mm and at most 6.15 mm and the thickness of the discharge chamber is at least 3.45 mm and at most 3.85 mm. The fill gas in the discharge chamber of the lamp according to the invention includes a halide composition comprising sodium iodide NaI and scandium iodide ScI₃, whereby the proportion of sodium iodide in the halide composition is at least 62 wt % and at most 76 wt %, and the proportion of scandium iodide in the halide composition is at least 22 wt % and at most 32 wt %. In the mercury-free gas-discharge lamp according to the invention, the fill gas comprises xenon gas under a pressure of at least 13 bar in a non-operational state, such that a colour temperature in the range of 3550K to 3850K is attained by the lamp when operated at an initial operating voltage of at least 39V and at most 51V Pertinent initial lamp parameters such as colour temperature, operating voltage, lumen output etc., apply for a lamp age of 15 hours according to ECE regulations. This is because these parameters are obtained after the first fifteen hours of operation of such a lamp, which is regarded as the ‘aging’ time.

The relatively high cold pressure of the xenon fill gas plays a decisive role in obtaining the desired low colour temperature, but it is necessary that all of the above mentioned conditions—lamp dimensions, fill gas composition, etc.,—be satisfied in order to obtain the colour temperature in the range given. Numerous experiments carried out while striving for the lamp according to the invention have surprisingly shown that, with the fill gas cold pressure, halide composition and bulb dimensions as outlined above, the desired colour temperature can be reliably achieved in a desired voltage range satisfying the D4 regulations mentioned above

An obvious advantage of the lamp according to the invention is that it can be used in place of a prior art headlamp, either as an automotive headlamp in a country such as Japan that requires a lower colour temperature for automotive headlamps, or as a motorcycle headlamp in other countries, allowing the motorcycle to be easily distinguished from other vehicles on the basis of the headlight colour, as already described above. Furthermore, the lamp according to the invention can be used in place of a prior art D4 headlamp without having to replace any existing electronics or fittings. Another obvious advantage is that the lamp according to the invention is mercury-free, giving this lamp a distinct advantage over other lamps having similar luminous flux characteristics but containing mercury.

The dependent claims and the subsequent description disclose particularly advantageous embodiments and features of the invention.

As mentioned above, the colour point obtained by a lamp during operation depends on many different factors. Extensive experimentation has also shown that the relative ratios of the components of the halide composition are also decisive. For example, the halide composition can consist of only sodium iodide NaI and scandium iodide ScI₃ in the ratio 70:30, i.e. 70% of the weight of the halide composition is made up of sodium iodide, while the remaining 30% of the weight is made of scandium iodide. However, a small addition of a further metal halide can have a positive influence on the colour point. Therefore, in a preferred embodiment of the invention, the halide composition comprises one or more halide additives from the group of zinc iodide ZnI₂, thallium iodide TlI, thorium iodide ThI₂, and the proportion of the halide additive in the halide composition is at most 15%. For example, in one embodiment of the lamp according to the invention, the halide composition can comprise sodium iodide NaI, scandium iodide ScI₃, thorium iodide ThI₂ and zinc iodide ZnI₂ in the ratio 64:27:2:7.

The electrodes of prior art lamps are generally made of tungsten, since tungsten has a very high melting point, as will be known to a person skilled in the art. A tungsten electrode that contains thorium (called a thoriated tungsten electrode) operates at a temperature below its melting temperature compared to a pure tungsten electrode, so that the electrode is not prone to deformation during operation. However, like mercury, thorium poses health and environmental risks. Thorium is a low-level radioactive material requiring precautions in handling so as to avoid inhalation or ingestion, and its use is also undesirable from an environmental point of view. Therefore, in a preferred embodiment of the invention, an electrode of the HID lamp is a thorium-free tungsten electrode, i.e. a tungsten electrode that does not comprise a thorium additive. To obtain a stable arc using such an electrode, experiments pertaining to the lamp according to the invention have shown that the dimensions of the electrode can play an important role. Maintenance of a stable arc depends to a large extent on the geometry of the electrodes, in particular their diameter, since the thickness of the electrodes governs the electrode temperature that is reached during operation, which in turn determines the commutation behaviour and the burn-back of the electrodes according to the ballast parameters. The diameter of the electrode within a pinch region of the lamp is therefore preferably at least 280 μm and at most 320 μm, and the diameter at the tip of the electrode is preferably at least 280 μm and at most 360 μm. The electrode according to the invention can be realised as a simple rod shape of uniform diameter from tip to pinch, or can be realised to be wider at the tip that at the pinch. These dimensions apply to the initial dimensions of the electrodes before burning.

Other objects and features of the present invention will become apparent from the following detailed descriptions considered in conjunction with the accompanying drawings. It is to be understood, however, that the drawings are designed solely for the purposes of illustration and not as a definition of the limits of the invention.

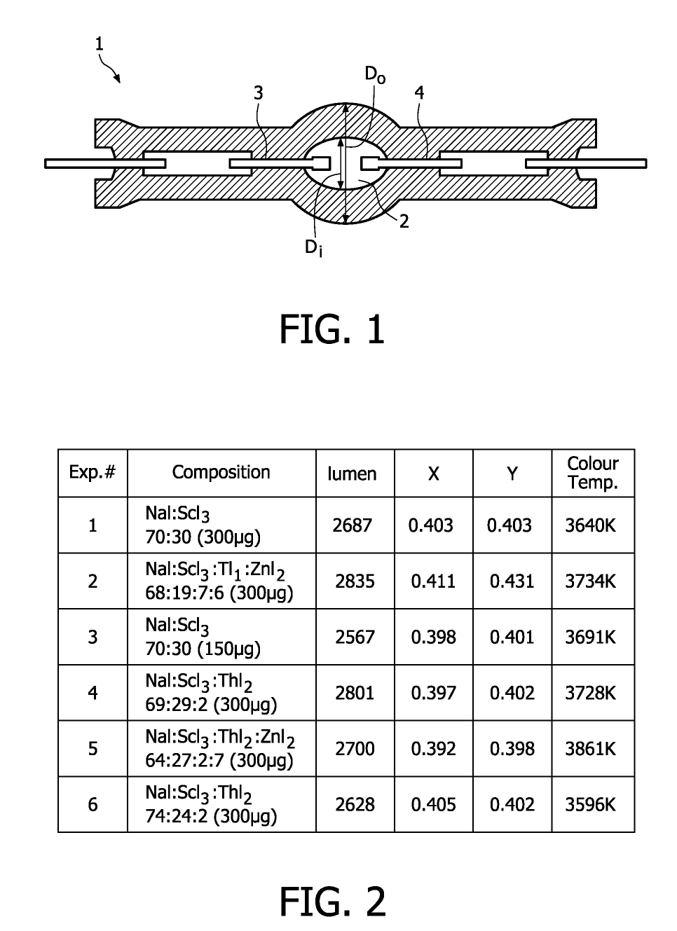

FIG. 1 shows a cross section of a mercury-free HID gas-discharge lamp according to an embodiment of the invention;

FIG. 2 shows a table of experimental results using a number of embodiments of the lamp according to the invention;

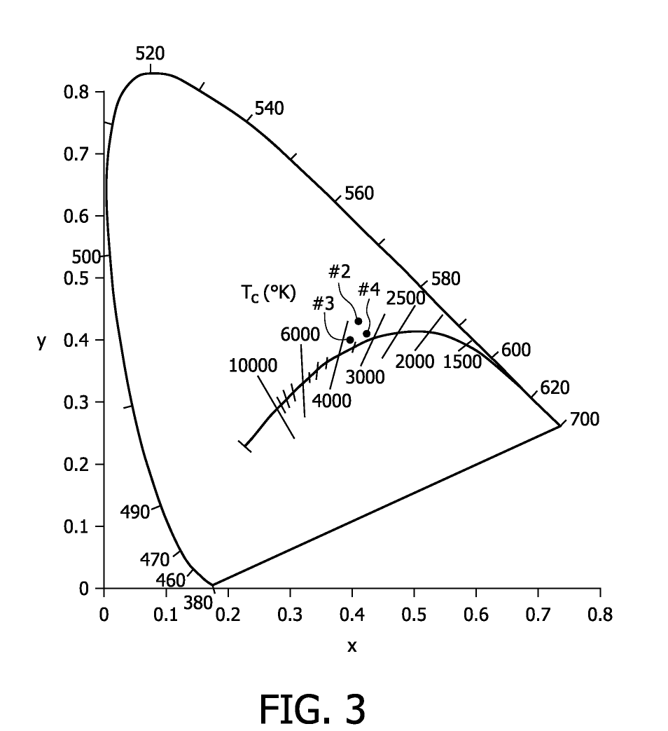

FIG. 3 shows a colour temperature chart.

In the drawings, like numbers refer to like objects throughout. Objects in the diagrams are not necessarily drawn to scale.

In FIG. 1, a cross section of a quartz glass gas-discharge lamp 1 is shown according to an embodiment of the invention. Essentially, the lamp 1 comprises a discharge chamber 2 containing a fill gas. Two electrodes 3, 4 protrude into the discharge chamber 2 from opposing ends of the lamp 1. During manufacturing, the quartz glass is pinched on both sides around the electrodes 3, 4 to seal the discharge chamber 2. The dimensions of the discharge chamber 2 pertinent to achieving the desired colour temperature of about 3700K are its capacity (or volume), and its inner diameter Dᵢ. Also pertinent is the thickness of the quartz glass around the discharge chamber 2, given by the outer diameter Dₒ. The inner and outer diameters Dᵢ, Dₒ are measured at the widest point of the discharge vessel. As already mentioned above, the capacity or volume of the discharge chamber 2 lies between 17 μl and 25 μl. The inner diameter Dᵢ is at least 2.3 mm and at most 2.5 mm, while the outer diameter Dₒ is at least 5.95 mm and at most 6.15 mm. The actual thickness of the glass enclosing the discharge chamber 2, i.e. half the difference between outer diameter Dₒ and inner diameter Dᵢ, is at least 1.724 mm and at most 1.925 mm, again, measured at the widest point of the discharge vessel. The dimensions of the lamp 1 are chosen such that these criteria are fulfilled, i.e. the length of the discharge chamber 2 is chosen such that the desired volume is obtained for a particular inner diameter Dᵢ, and the manufacturing process is controlled so that the thickness of the quartz glass enclosing the discharge chamber 2 satisfies the chosen inner diameter Dᵢ and outer diameter Dₒ.

The electrodes 3, 4 are essentially thorium-free tungsten rods that protrude into the discharge chamber 2 and are optically separated from each other by a distance of 4.2 mm according to the R99 regulation. The electrodes of a lamp according to the invention can be realised as simple rods of uniform thickness from base to tip. However, the thickness of the electrodes can equally well vary over different stages of the electrodes, so that, for example, an electrode is thicker at its tip and narrower at the base. In the embodiment described in the diagram, the electrodes 3, 4 are shown to be somewhat thicker at their tips, where the outer diameter is up to 360 μm, and the diameter of the electrodes 3, 4 in the pinch region can be up to 320 μm (these values for diameter are initial values before burning).

For the sake of clarity, the diagram shows only the parts that are pertinent to the invention. Not shown is the ballast that is required by the lamp for control of the voltage across the electrodes. When the lamp 1 is switched on, the ballast's igniter rapidly pulses an ignition voltage at several thousand volts across the electrodes 3, 4 to initiate a discharge arc. The heat of the arc vaporizes the metal salts in the fill gas. Once the arc of high luminous intensity is established, the ballast regulates the power and current, so that the voltage across the electrodes 3, 4 accordingly drops to the operational level, in this example, to a level between 39V and 51V.

Since potentially damaging ultraviolet light is generated by the arc in the HID lamp 1, the quartz discharge chamber may be enclosed by a hard glass shield or envelope to absorb this radiation. The light that is passed through is then collected and distributed using HID-specific optics, such as reflectors and collimators in headlamp construction for ensuring that as much as possible of the light output is put to use. Since these and other additional components will be known to a person skilled in the art, they will not be explained in more detail.

In FIG. 2, a table is shown with experimentally obtained measurements for a number of lamps constructed and filled according to the invention. The first column ‘Exp. #’ indicates the experiment number. Each experiment number corresponds to a particular lamp manufactured for that experiment. The ‘Composition’ column gives the halide composition used in the lamp. The ‘lumen’ values, the ‘X’ and ‘Y’ values and the ‘colour temperature’ values was observed after 15 hours aging according to the ECE aging cycle. For each experiment, the xenon fill pressure in the discharge chamber was approximately 14 bar cold pressure. For each experiment except experiment #3, the weight of the halide composition was 300 μg. In experiment #3, the weight of the halide composition was 150 μg.

The ‘X’ and ‘Y’ values listed in the table give pairs of coordinates in a colour space. Such a colour space is shown in the ‘guitar pick’ diagram of FIG. 3, which is a standard chromaticity diagram that will be known to a person skilled in the art. This type of diagram is usually rendered in colour, so that the right-hand corner corresponds to the red primary colour, the lower left-hand corner corresponds to the blue primary colour, and the upper left corresponds to the green primary colour. The colours merge into each other, giving a white region towards the centre of the colour space. The thick black line travelling in a curve from right to left is known as the Planckian locus, giving the colours of a black-body radiator being heated through progressively higher temperatures.

The colour temperature of a lamp can be read from the chromaticity diagram by plotting the X and Y coordinates that have been obtained using measurement techniques that are known to a person skilled in the art. For the sake of clarity, only three colour temperature points corresponding to experiments #2, #3 and #4 are indicated in this diagram.

As can be seen from the colour space diagram and the table, each of the lamps yields a colour temperature below 4000K. The lamps of Experiments 3 and 4 give colour temperatures closest to the target colour temperature of 3700K, with deviations of minus 9K and plus 28K respectively. The next closest colour temperatures are achieved by the lamps of Experiments 2 and 5, with deviations from 3700K of plus 34K and plus 44K respectively. The lamps of Experiments 1 and 6 both yield colour temperatures closer to 3600K.

The differences in observed colour temperature are explained by the differences in NaI/ScI3 ratio, the proportion of halide additive, and the actual weight of the total halide composition. For example, for experiment #1, the total weight of the halide composition was 300 μg, whereas experiment #3 used a total weight of 150 μg. In both cases, the NaI/ScI3 ratio was the same. The difference in halide composition weight caused the difference in luminous flux and in the observed colour temperature values for these two experiments.

As can be seen from the table of results, the colour temperature delivered by each of the lamps, in the region of 3700K, is quite satisfactory. In particular, the lamp of experiment #4 delivers the desired colour temperature together with a very satisfactory light output close to 2800 lumen, making this lamp particularly suitable for automotive applications. The lamp of experiment #1 also delivers satisfactory colour temperature and a light output close to 2690 lumen, which is somewhat lower than that of experiment #4. Of the remaining lamps, experiments #3 and #6 both yield a satisfactory colour temperature but comparatively low light output of about 2600 lumen.

Although the present invention has been disclosed in the form of preferred embodiments and variations thereon, it will be understood that numerous additional modifications and variations could be made thereto without departing from the scope of the invention. For the sake of clarity, it is also to be understood that the use of “a” or “an” throughout this application does not exclude a plurality, and “comprising” does not exclude other steps or elements.

1. A mercury-free high intensity gas-discharge lamp (1) with nominal power in the range of 25 W to 40 W, comprising a quartz glass discharge chamber (2) enclosing a fill gas and comprising a pair of electrodes (3, 4) arranged at opposing ends of the discharge chamber (2) and extending into the discharge chamber (2), wherein
the capacity of the discharge chamber (2) is greater than or equal to 17 μl and less than or equal to 25 μl;
the inner diameter of the discharge chamber (2) is at least 2.3 mm and at most 2.5 mm;
the outer diameter of the discharge chamber (2) is at least 5.95 mm and at most 6.15 mm;
the thickness of the discharge chamber (2) is at least 1.725 mm and at most 1.925 mm;
the fill gas in the discharge chamber (2) of the lamp (1) includes a halide composition comprising sodium iodide NaI and scandium iodide ScI₃, whereby the proportion of sodium iodide in the halide composition is at least 62 wt % and at most 76 wt %, and the proportion of scandium iodide in the halide composition is at least 22 wt % and at most 32 wt %
and the fill gas comprises xenon gas under a pressure of at least 13 bar in a non-operational state,
such that a colour temperature in the range of 3550K to 3850K is attained by the lamp (1) when operated with an initial operating voltage of at least 39V and at most 51V.

2. A lamp (1) according to claim 1, wherein the halide composition comprises one or more halide additives from the group consisting of: zinc iodide ZnI₂, thallium iodide TlI, thorium iodide ThI₂, and wherein the proportion of the halide additive in the halide composition is at most 15%.

3. A lamp (1) according to claim 1, wherein an electrode (3, 4) of the lamp (1) is a thorium-free tungsten electrode (3, 4), and wherein
the diameter of the electrode (3, 4) within a pinch region of the lamp (1) is at least 280 μm and at most 320 μm;
and the diameter at the tip of the electrode (3, 4) is at least 280 μm and at most 360 μm.
